(19) United States
(12) Patent Application Publication
(10) Pub. No.: US 2016/0132561 A1
(43) Pub. Date: May 12, 2016

(54) EXPIRATION TAG OF DATA

(71) Applicant: HEWLETT-PACKARD DEVELOPMENT COMPANY, L.P., Houston, TX (US)

(72) Inventors: Parag Doshi, Marietta, GA (US); Chandra H. Kamalakantha, Plano, TX (US)

(21) Appl. No.: 14/899,046

(22) PCT Filed: Jun. 28, 2013
(86) PCT No.: PCT/US2013/048578

§ 371 Date: Dec. 16, 2015

(51) Int. Cl. G06F 17/30; H04L 29/06

(52) U.S. Cl. CPC G06F 17/30525; G06F 17/30551; H04L 63/0428

(57) ABSTRACT

A destination device may check an expiration tag of data received from a source device. The expiration tag may include a date. The destination device may not accept the data if the date of the expiration to is less than or equal to a current date. Further, the destination device unit may deny access to the data and/or delete the data after the data is stored at the destination device, if the date of the expiration tag is less than or equal to the current date.

### BACKGROUND

Data may be shared between users or devices over a network. For example, a first user may send an image or email to a second user or broadcast a comment to a plurality of users. Increasingly, such data is being shared via services specializing in sharing content. Providers of such services are increasingly challenged to share this data according to user preferences.

### BRIEF DESCRIPTION OF THE DRAWINGS

The following detailed description references the drawings, wherein:

FIG. 1 is an example bock diagram of a destination device to check an expiration tag of data;

FIG. 2 is an example block diagram of a source device to send data including an expiration tag to a destination device;

FIG. 3 is an example block diagram of a computing device including instructions for adding an expiration tag to data to be shared with a destination device; and

FIG. 4 is an example flowchart of a method for denying access to or deleting data based on an expiration tag of data.

### DETAILED DESCRIPTION

Specific details are given in the following description to provide an understanding of examples of the present techniques. However, it will be understood that examples of the present techniques may be practiced without these specific details. For example, systems may be shown in block diagrams in order not to obscure examples of the present techniques in unnecessary details. In other instances, well-known processes, structures and techniques may be shown without unnecessary detail in order to avoid obscuring the examples of the present techniques.

The advent of the Internet, mobile devices, and data explosion in structured and unstructured form has led to greet sharing of information while also exposing critical and sometimes sensitive information into the permanent record that is today's Internet. For example, it is common occurrence nowadays to find cloud services such as Facebook, Twitter, Box.Net, iCloud, Samsung Personnel Cloud Storage, Google docs, etc., which allow subscribers to share photos, videos, emails, comments, even real enterprise data, etc. with the subscribers' friend circle. Thus, content may be stored and/or shared across various devices or systems without permission of the content's author.

In some cases, the content's author may wish to limit or prevent the sharing or storing of the content. For example, the author may have sent the content by mistake or sought to have kept the content private. It is a routine occurrence these days for organizations, people, etc. share data amongst friends, colleagues, etc. However, current content sharing services lack capability for some of that shared data to be destroyed after a certain duration, including data that is downloaded for offline viewing.

Examples of present techniques may allow for safe destruction of original data as wail as shared a that has been downloaded for offline viewing. For example, a device may include a tag unit and an access unit. The tag unit may check an expiration tag of data received from a source device. The expiration tag may include a date. The access unit may ac pt the received data if the date of the expiration tag is greater a current date. The access unit may not accept the data if the date of the expiration tag is less than or equal to a current date. Further, the access unit may deny access to the data and/or delete the data after the data is stored at the destination device, if the date of the expiration tag is less than or equal to the current date.

Thus, examples may provide a comprehensive, end-to-end system for secure deletion of original content as well as shared content that may have been downloaded for offline viewing. Through use of tags, this system may be applied independently of the type of device(s) used. Hence, examples may span across consumer as well as enterprise industries. For instance, examples may apply in the consumer industry to secure photo/video sharing, publishing content in blogs or on the web. Examples may also apply to enterprise industries where data confidentially is a concern, such as where regulations demand that personal data be shared under the strict adherence of the Personal Identifiable Information Act.

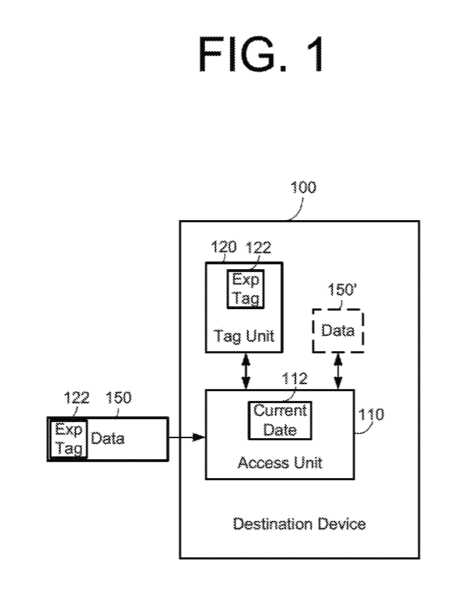

Referring now to the drawings, FIG. 1 is an example block diagram of a destination device 100 to check an expiration tag 122 of data 150. The destination device 100 may be any type cat device to receive data from a source device (not shown). Examples of the destination device 100 may include a workstation, terminal, laptop, tablet, desktop computer, thin client, remote device, mobile device, wireless device and the like. The source device may be any type of device to share data with the destination device 100. Examples of the source device may include a server, hub, workstation, terminal, laptop, tablet, desktop computer, mobile device, wireless device, network element, a virtual host, a virtual machine (VM) and the like.

In FIG. 1, the destination device 100 is shown to include an access unit 110 and a tag unit 120. The access and tag units 110 and 120 may include, for example, a hardware device including electronic circuitry for implementing the functionality described below, such as control logic and/or memory. In addition or as an alternative, the access and tag units 110 and 120 may be implemented as a series of instructions encoded on a machine-readable storage medium and executable by a processor.

The tag unit 120 may check an expiration tag 122 of data 150 received from the source device. The expiration tag 122 may include a date (not shown). The term tag may refer to any type of information about the data 150, such as metadata. The access unit 110 may accept the received data 150 if the date of the expiration tag is greater a current date 112. However, the access unit 110 may not accept the data 150 if the date of the expiration to 122 is less than or equal to a current date 112. The current date 112 may be continuously updated and reflect the present date and/or time. For example, the destination device 100 may include a clock (not shown) that updates the current date 112 and/or receive the current date 112 externally, such as via an atomic clock.

The date of the expiration tag 122 and/or the current date 112 may include, for example, a year, month, day, hours, minutes, seconds and the like. Any type of format for recording the date may be used. For example, the expiration tag 122 may be recorded as “2014-08-15.08:3050”, which translates to the date Aug. 15, 2014 and time 8:30:59 AM, with the “59” denoting seconds. The expiration tag 122 may also include additional time-related information, such as a time zone.

For instance, assuming the date of the expiration tag 122 is Aug. 15, 2014 and the current date 112 is Sep. 16, 2013, when the data 150 is received by the access unit 110, the access unit 110 may accept the data 150. Thus, the destination device 100 may store the data 150. However, the destination device 100 may still continue to check the date of the expiration tag 122. Further, the access unit 110 may deny access to the stored data 150′ and/or delete the stored data 150′ if the date of the expiration tag 122 of the stored data 150′ is less than or equal to the current date 112. For example, if the current date 112 reaches Aug. 16, 2014 and the expiration tag 122 is Aug. 15, 2014, the access unit 110 may delete the stored data 150′. The access unit 110 may delete the stored data 150′ such that the stored data 150′ is unrecoverable. For example, the access unit may overwrite the stored data 150′ and/or scramble the stored data 150′. The data 150 may be stored, for example as a Binary Large Object (BLOB). The access unit 110 may deny access to the stored data 150 by changing file permissions or attributes.

The access unit 120 may check any type of data for the expiration tag 112, regardless of the source. For example, whether the data 150 is received externally, such as via TCP/IP, SMTP, HTTP, or read internally, such as via memory (not shown), the access unit 120 may check any data 150 read or shared.

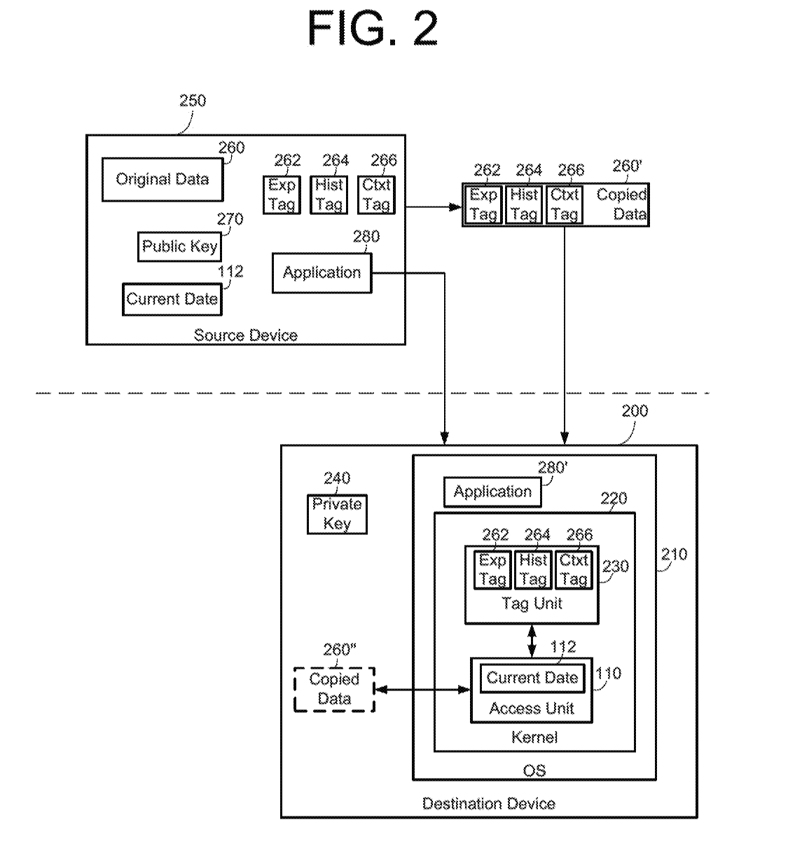

FIG. 2 is an example block diagram of a source device 250 to send data 260 including an expiration tag 262 to a destination device 200. The destination device 200 may be any type of device to receive data from the source device 250. Examples of the destination device 200 may include a workstation, terminal, laptop, tablet, desktop computer, thin client, remote device, mobile device, wireless device and the like. The source device 250 may be any type of device to share data with the destination device 200. Examples of the source device 250 may include a server, hub, workstation, terminal, laptop, tablet, desktop computer, mobile device, wireless device, network element, a virtual host, a virtual machine (VM) and the like.

The destination device 200 of FIG. 2 may include at least the functionality and/or hardware of the destination device 100 of FIG. 1. For example, the destination device 200 of FIG. 2 includes the access unit 110 of FIG. 1 and a tag unit 230 that includes at least the functionality described of the tag unit 120 of FIG. 1. The destination device 200 may interface with the source device 250, such as over a network.

The destination device 200 may download an application 280 from the source device 250 before the data 260 is received. The term application may refer to any type of software that causes the destination device 200 to perform a task. The destination device 200 may include an operating system (OS) 210 and a kernel 220 of the OS 210 may be modified by the downloaded application 280′.

in one example, the application 280′ may run scripts or macros on the destination device 200. In yet another example, the destination device 200 may register with or subscribe to the source device 250 before the destination device 200 is able to download the application 280′. In this case, the destination device 200 may agree to download and install the application 280 in order to receive content from the source device 250.

The OS 210 may represent a collection of software that manages computer hardware resources and provides common services for computer programs. Examples of the OS 210 may include Android, BSD, iOS, GNU/Linux, OS X, QNX, Microsoft Windows, Windows Phone, IBM z/OS and the like. The kernel 220 may he a computer program that manages input/output requests from software into data processing instructions for a central processing unit (CPU) and other electronic components of a computing device, such as the destination device 200. A process of the OS 210 that makes a request of the kernel 220 may be called a system call. Various kernel designs may differ in how they manage system calls (time-sharing) and resources.

The data 260′ received by the destination device 200 may be a copy of original data 260 stored at the source device 250. The original data 260 may have been captured or created by the source device 250. The tag and access units 230 and 120 may be part of the kernel 220 and/or controlled by the kernel 220. Here, the tag and access units 230 and 120 are shown to be part of the kernel 220.

The source device 250 may add the expiration tag 262 to the copied data 260′ received by the destination device 200. The destination device 200 may not alter the expiration tag 262 of the received data. For example, the application 280 may modify the OS 210 to and/or prevent the OS 210 from modifying the expiration tag 262, in order to reduce a likelihood of unauthorized extensions of the date of the expiration tag 262.

Similar to the destination device 200, the source device 250 may also deny access to and/or delete the original data 260 if the date of the expiration tag 262 is less than or equal to the current date 122. Thus, if the date of the expiration tag 262 expires, both the original data 260 at the source device 250 and the copied data 260″ at the destination device 200 may be deleted or become inaccessible.

Hence, the downloaded or offline data 260″, such as images or other types of multimedia, may also be deleted or become inaccessible after the date of expiration tag 262 expires. The expiration tag 262 may be checked at the source device 250 and/or the destination device 200 continuously and/or in response to an interrupt. For example, a background process or scheduler may run that monitor and controls access to and/or deletion of the data 260 based on the expiration tags 262.

The data 260′ may further include a context tag 266. The context tag 266 may include a location type, a device type, and the like. The source device 250 may add the context tag 266 to the data 260′. Examples of the location type may include a workspace, a private network, a public network, an airport, a home location, and the like. Examples of the device type may include a mobile device, a camera, an authorized device, and the like.

The access unit 120 of the destination device 200 may deny access to and/or delete the copied data 260′ if the location type does not match a current location of the destination device 200 and/or the device type does not match a type of the destination device 200. For example, the context tag 266 may indicate that the copied data 260″ is only viewable by a cellular device or at a certain location, such as near a public landmark or at a user's home. Similarly, the source device 250 may deny access to and/or delete the original data 260 if the location type does not match a current location of the source device 250 and or the device type does not match a type of the source device 250.

The data 260′ may further include a historical tag 264. The historical tag 264 may include a record of a location the copied data 260′ was previously stored, any modifications to the copied data 260′ and the like. Example modifications may include data creation date, data access date, data modified date and the like. The access unit 120 may deny access to and/or delete the data 260′ based on the historical tag 264. For example, the access unit 120 may deny access to and/or delete the copied data 260′ if the historical tag 264 indicates that the copied data 260′ has been tampered with or corrupted.

The copied data 260′ may be encrypted before being transmitted to the destination device 200 and then decrypted upon receipt by the destination device 200. For example, the source device 250 may encrypt the data 260 before the data 260 is transmitted to the destination device 200 using a public key 270. The destination device 200 may then decrypt the received data 260′ using a private key 240. The public key 270 may be widely distributed, while the private key 240 may be known only by the destination device 200. Where there are a plurality of destination devices 240, different destination devices 240 may have different private keys 240.

Although different, the public and private keys 240 and 270 may form a key pair that are mathematically linked. One of the public and private keys 240 and 270 may lock or encrypt the data 260, and the other of the public and Ovate keys 240 and 270 may unlock or decrypt the data 260. Neither of the public and private keys 240 and 270 may perform both functions by itself.

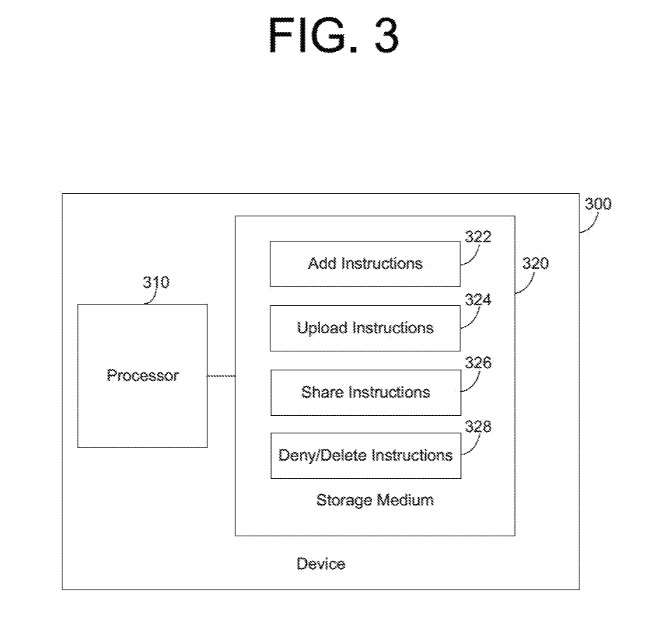

FIG. 3 is en example block diagram of a computing device 300 including instructions for adding an expiration tag to data to be shared with a destination device. In the example of FIG. 3, the computing device 300 includes a processor 310 and a machine-readable storage medium 320. The machine-readable storage medium 320 further includes instructions 322, 324, 326 and 328 for adding en expiration tag to data to be shared with a destination device.

The computing device 300 may be, for example, a secure microprocessor, a notebook computer, a desktop computer, an all-in-one system, a server, a network device, a wireless device, or any other type of user device capable of executing the instructions 322, 324, 326 and 328. In certain examples, the computing device 300 may include or be connected to additional components such as memories, sensors, displays, etc.

The processor 310 may be, at least one central processing unit (CPU), at least one semiconductor-based microprocessor, other hardware devices suitable for retrieval and execution of instructions stored in the machine-readable storage medium 320, or combinations thereof. The processor 310 may fetch, decode, and execute instructions 322, 324, 326 and 328 to implement adding the expiration tag to data to be shared with the destination device. As an alternative or in addition to retrieving and executing instructions, the processor 310 may include at least one integrated circuit (IC), other current logic, other electronic circuits, or combinations thereof that include a number of electronic components for performing the functionality of instructions 322, 324, 326 and 328.

The machine-readable storage medium 320 may be any electronic, magnetic, optical, or other physical storage device that contains or stores executable instructions. Thus, the machine-readable storage medium 320 may be, for example, Random Access Memory (RAM), an Electrically Erasable Programmable Read-Only Memory (EEPROM), a storage drive, a Compact Disc Read Only Memory (CD-ROM), and the like. As such, the machine-readable storage medium 320 can be non-transitory. As described in detail below, machine-readable storage medium 320 may be encoded with a series of executable instructions for adding the expiration tag to data to be shared with the destination device.

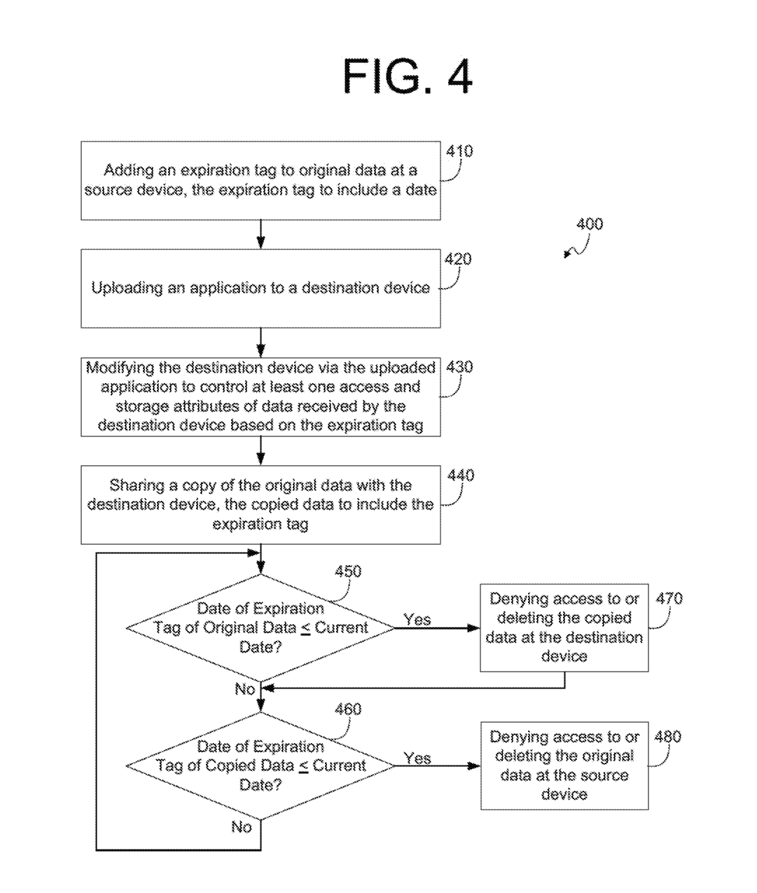

Moreover, the instructions 322, 324, 326 and 328 when executed by a processor (e.g., via one processing element or multiple processing elements of the processor) can cause the processor to perform processes, such as, the process of FIG. 4. For example, the add instructions 322 may be executed by the processor 310 to add an expiration tag to original data at a source device, such as the computing device 300. The expiration tag may include a date.

The upload instructions 324 may be executed by the processor 310 to upload an application (not shown) to a destination device (not shown). The application may configure the destination device to check the expiration tag of data received by the destination device. The share instructions 326 may be executed by the processor 310 to share a copy of the original data with the destination device. The copied data may include the expiration tag.

The deny/delete instructions 328 may be executed by the processor 310 to deny access to and/or delete the original data after the data of the expiration tag of the original data is less than or equal to a current date. Further, the application may configure the destination device to deny access to and/or delete the copied data after the date of the expiration tag of the copied data is less than or equal to the current date.

FIG. 4 is an example flowchart of a method 400 for denying access to or deleting data based on an expiration tag of data. Although execution of the method 400 is described below with reference to the devices 200 and 250, other suitable components for execution of the method 400 can be utilized, such as the device 100. Additionally, the components for executing the method 400 may be spread among multiple devices (e.g., a processing device in communication with input and output devices). In certain scenarios, multiple devices acting in coordination can be considered a single device to perform the method 400. The method 400 may be implemented in the form of executable instructions stored on a machine-readable storage medium, such as storage medium 320, and/or in the form of electronic circuitry.

At block 410, the source device 250 adds an expiration tag 262 to original data 260. The expiration tag 262 may include a date. Next, at block 420, the source device 250 uploads an application 280 to the destination device 200. The destination device 200 may register with the source device 250 before the source device 250 uploads the application 280 to the destination device 200. Then, at block 430, the application 280 modifies the destination device 200 to control at least one of access and storage attributes of data received by the destination device 200 based on the expiration tag 262.

Afterward, at block 440, the source device 250 shares a copy 260′ of the original data with the destination device 200. The copied data 260′ includes the expiration tag 262. At block 450, the source device 250 compares the date of the expiration tag 262 of the original data 260 to a current date 112. If the date of expiration tag 262 of the original data 260 is less than or equal to the current date 112, the method 400 flows to block 470 where the source device 250 may deny access to and/or delete the original data 260.

At a same or different time as block 450, the destination device 200, at block 460, may compare the date of the expiration tag 262 of the copied data 260″ to the current date 112. If the date of the expiration tag 262 of the copied data 260″ is less than or equal to the current date 112, the method 400 flows to block 480 where the destination device 200 may deny access to and/or delete the copied data 260″ . The comparisons at blocks 450 and 460 may be carried continuously in order to determine when data has expired.

The source device 250 may encrypt the copied data 260′ using a public key 270 before sending the copied data 260′ to the destination device 200. The application 280′ uploaded to the destination device 200 may include a private key 240. In one example, the destination device 200 may not directly access the private key 240. Instead, the private key 240 may only be accessed through the application 280′ in order to prevent corruption of and/or unauthorized access to the private key 240.

Further, the application 280′ may prevent the destination device 200 from altering the expiration tag 262 of the copied data 260″. Thus, a likelihood of tampering with the expiration tag 262 may be reduced. In addition, the application 280′ may prevent the destination device 200 from accessing the copied data 260″ before checking the expiration tag 262 of the copied data 260″. Hence, data having an expired expiration tag 262 may be prevented from or have a reamed likelihood of being accessed.

According to the foregoing, examples of present techniques provide for safe destruction of original data as well as shared data that has been downloaded for offline viewing. Thus, examples may provide a comprehensive, end-to-end system for secure deletion of original and copied content. Through use of tags, this system may be applied independently of the type of device(s) used. Hence, examples may span across consumer as well as enterprise industries.

1. A destination device, comprising:
a tag unit to check an expiration tag of data received from a source device, the expiration tag to include a date; and
an access unit to accept the received data when the date of the expiration tag is greater than a current date, wherein the access unit is to not accept the data when the date of the expiration tag is less than or equal to a current date,
the access unit is to at least one of deny access to the data and delete the data after the data is stored at the destination device, when the date of the expiration tag is less than or equal to the current date; and
the access unit is to at least one of deny access to and delete the received data based on a historical tag included in the received data, the historical tag to include a record of a modification to the received data.

2. The destination device of claim 1, wherein
the destination device is to download an application from the source device before the data is received,
the destination device includes an operating system (OS) and a kernel of the OS is modified by the application, and
the tag and access units are at least one of part of the kernel and controlled by the kernel.

3. The destination device of claim 1, wherein,
the source device is to add the expiration tag to the data received by the destination device, and
the destination device can not alter the expiration tag of the received data.

4. The destination device of claim 1, wherein
the data received by the destination device is a copy of original data stored at the source device, and
the source device is to at least one of deny access to and delete the original data when the date of the expiration tag is less than or equal to the current date.

5. The destination device of claim 4, wherein,
the copied data further includes a context tag, the context tag to include at least one of a location type and device type, and
the access unit is to at least one of deny access to and delete the copied data when at least one of the location type does not match a current location of the destination device and the device type does not match a type of the destination device.

6. The destination device of claim 5, wherein,
the source device is to add the context tag to the copied data, and
the source device is to at least one of deny access to and delete the original data when at least one of the location type does not match a current location of the source device and the device type does not match a type of the source device

7. (canceled)

8. The destination device of claim 1, wherein,
the source device is to encrypt the data before the data is transmitted to the destination device using a public key, and
the destination device is to decrypt the received data using a private key.

9. The destination device of claim 1, wherein,
the date includes at least one of year, month, day, hours, minutes and seconds, and
the access unit deletes the data such that the data is unrecoverable.

10. (canceled)

11. The non-transitory computer-readable storage medium of claim 14, wherein the destination device is to register with the source device before the source device uploads the application to the destination device

12. (canceled)

13. The non-transitory computer-readable storage medium of claim 14, wherein,
the application is to prevent the destination device from altering the expiration tag of the copied data, and
the application is to prevent the destination device from accessing the copied data before checking the expiration tag of the copied data.

14. A non-transitory computer-readable storage medium storing
instructions that, when executed by a processor of a source device, cause the
processor to:
add an expiration tag to original data at the source device, the expiration tag to include a date;
upload an application to a destination device, the application to configure the destination device to check the expiration tag of data received by the destination device;
share a copy of the original data with the destination device, the copied data to include the expiration tag; and
at least one of deny access to and delete the original data after the date of the expiration tag of the original data is less than or equal to a current date.

15. The non-transitory computer-readable storage medium of claim 14, wherein the application is to configure the destination device to at least one of deny access to and delete the copied data after the date of the expiration tag of the copied data is less than or equal to the current date.

16. The destination device of claim 1, wherein the access unit is to at least one of deny access to and delete the received data based on a historical tag included in the received data when the historical tag indicates that the received data has been at least one of tampered with and corrupted.

17. The destination device of claim 16, wherein the record of the modification to the received data comprises at least one of a data creation date, a data access date, and a data modified date.

18. A method comprising:
checking an expiration tag of data received from a source device, the expiration tag to include a date;
accepting the received data or not depending on whether the date of the expiration tag is greater than a current date, wherein the access unit is to not accept the data when the date of the expiration tag is less than or equal to a current date; and
at least one of denying access to and deleting the received data when a historical tag included in the received data indicates that the received data has been tampered with or corrupted, the historical tag to include a record of a modification to the received data.

19. The destination device of claim 18, wherein the record of the modification to the received data comprises a data access date.

20. The destination device of claim 18, wherein the record of the modification to the received data comprises a data modified date.
